(19) United States
(12) Patent Application Publication
(10) Pub. No.: US 2022/0180444 A1
(43) Pub. Date: Jun. 9, 2022

(54) TRUST HAVING A MAXIMUM DISTRIBUTION BENEFIT TO A BENEFICIARY AFTER THE BENEFICIAIRY HAS REACHED RETIREMENT AGE AND A PROCESS FOR DEVELOPING SUCH A TRUST

(71) Applicant: William E. Hesch, Cincinnati, OH (US)

(72) Inventor: William E. Hesch, Cincinnati, OH (US)

(21) Appl. No.: 17/680,595

(22) Filed: Feb. 25, 2022

Related U.S. Application Data
(63) Continuation of application No. 16/553,847, filed on Aug. 28, 2019, now abandoned.

(51) Int. Cl. G06Q 40/06; G06Q 10/10

(52) U.S. Cl. CPC G06Q 40/06; G06Q 10/10

(57) ABSTRACT

A process for drafting or improving a retirement trust is disclosed. The process for drafting and improving the retirement trust provides for a grantor to fund the trust and allocate at least one portion of the trust to at least one beneficiary. The process also provides a working requirement of the at least one beneficiary to receive the distribution until the at least one beneficiary attains a pre-determined age. Upon reaching the pre-determined age the trust assets are managed to provide a lifetime income to the at least one beneficiary.

### FIELD OF THE INVENTION

The present disclosure provides a trust and a method of delivering benefits promised as part of a trust. The present disclosure also provides a trust and a method of modifying the delivery of benefits promised as part of that trust by requiring the trust beneficiary(s) with a requirement that they work to receive benefits under such a trust and providing a benefit upon reaching retirement.

### BACKGROUND OF THE INVENTION

Retirement Trusts and Defined Benefit Trusts (both of which are referred to hereafter as “Trusts”) have traditionally played a vital role in providing income for many beneficiaries. These plans typically pay a regular income stream to beneficiaries for many years, sometimes decades. The amount of the payments is usually determined based on the financial need of the beneficiary as determined by the grantor.

It is well known that the younger generations are not saving enough for their retirement. IRAs are not being used and social security will likely not be an available source of retirement income for our younger generations when they retire. The intended purpose of such a trust or a retirement trust is to act as a retirement plan for the Grantor's beneficiaries (e.g., children) who may otherwise not have anything saved for retirement. Such a trust can allow the Grantor (or Grantors) to hold assets in trust for the benefit of their beneficiary(s) (e.g., children) until the beneficiary(s) reach a pre-determined age (e.g., commonly 62). Upon reaching the pre-determined age the trust assets are distributed to the beneficiary(s) as a retirement distribution for their lifetime.

This trust is typically used by baby boomer clients whose children are already old enough to be out of college and in the work force. These clients want the benefits of using a revocable trust in their estate plans but are concerned with their children's (or other beneficiaries') financial stability when they retire. They have these concerns for many reasons, including: (1) their children's past financial decision making (i.e., good or poor); (2) have children who are entrepreneurs and are worried those children won't have a nest egg for their retirement; (3) children have potential creditor problems and don't want their children inheriting trust assets outright in a lump sum distribution; or (4) they believe social security benefits will not be there for their children.

Therefore, it seems the ideal remedy is an alternative retirement trust income system that can preserve distributions to a beneficiary over a lifetime, but provides a revocable trust that becomes irrevocable upon the death of the Grantor (or Grantors), divides the trust into sub-trusts for each beneficiary, provides each beneficiary with the right to certain distributions of their sub-trust until that beneficiary reaches a pre-determined age, and provides for a work requirement upon the beneficiary in order to receive the full, entitled distribution until the beneficiary reaches the pre-determined age when distributions are made for a pre-determined period of time, such as the lifetime of the beneficiary.

### SUMMARY OF THE INVENTION

The present disclosure provides for a process for drafting and improving a trust wherein a grantor funds the trust and allocates at least one portion of the trust to at least one beneficiary. The at least one portion of the trust provides a distribution to the at least one beneficiary until the at least one beneficiary obtains a pre-determined age. The process for drafting and improving the trust comprising the steps of: a) funding the trust by the grantor; b) determining the pre-determined age of the at least one beneficiary by the grantor; c) determining the at least one portion of the trust by the grantor to provide the distribution to the at least one beneficiary until the at least one beneficiary obtains the pre-determined age; d) providing a working requirement of the at least one beneficiary in order to receive the distribution; e) drafting a trust document incorporating the working requirement therein; f) determining a corrected at least one portion of the trust by applying the trust adjustment factor determined in the step d2) to the at least one portion of the trust; and, g) distributing the corrected at least one portion of the trust to the at least one beneficiary according to the trust document incorporating the working requirement until the at least one beneficiary attains the pre-determined age determined in step b).

The working requirement of step d) comprises the steps of: 1) determining an annual wage of the at least one beneficiary; 2) determining a trust adjustment factor by comparing the annual wage of the at least one beneficiary determined in the step d1) with the pre-determined age of the at least one beneficiary determined in step b).

### BRIEF DESCRIPTION OF THE DRAWINGS

FIG. 1 is a flow chart of an exemplary process for creating a trust, or modifying an existing trust, to incorporate a work requirement and distributing assets of the trust incorporating a work requirement to a beneficiary consistent with the present disclosure;

FIG. 2 is a flow chart of an exemplary process for creating a work requirement for a trust consistent with the present disclosure;

FIG. 3 is a flow chart of an exemplary process for creating a sub-trust and pre-determined age of the process for creating a trust incorporating a work requirement;

FIG. 4 is a flow chart of an exemplary process for determining the work requirement of the process for creating a trust, or modifying an existing trust, to incorporate a work requirement;

FIG. 5 is a flow chart of an exemplary process for determining whether a correction is made to the entitled distribution of a beneficiary due to a disability;

FIG. 6 is a flow chart of an exemplary process for determining whether a correction is made to the entitled distribution of a beneficiary due to the beneficiary being a stay-at-home parent; and,

FIG. 7 is a is a flow chart of an alternative exemplary process for creating a trust, or modifying an existing trust, to incorporate an optional work requirement, an optional disability requirement, an optional stay-at-home parent consideration, an optional total house-hold income determination consistent with the present disclosure, and/or an optional a non-optional reimbursement government or other payment and distributing assets of the trust incorporating a work requirement to a beneficiary.

### DETAILED DESCRIPTION OF THE INVENTION

As mentioned supra, the process to draft a trust, modify an existing trust, and the resulting trust document described herein can typically be used by baby-boomer clients whose children are already old enough to be out of college and in the work force. These clients want the benefits of using a revocable trust in their estate plans but are concerned with their children's (or other beneficiaries) financial stability when they retire. They have these concerns for many reasons, including: (1) their children's past financial decision making; (2) have children who are entrepreneurs and are worried those children won't have a nest egg for their retirement; (3) children have potential creditor problems and don't want their children inheriting trust assets outright in a lump sum distribution; or (4) they believe social security benefits will not be there for their children.

As used herein, a “trust” (also called a “retirement trust” herein) is a relationship where property is held by one party for the benefit of another party. A trust is created by the owner, also called a “settlor”, “trustor” or “grantor” who transfers property to a trustee. The trustee holds that property for the trust's beneficiaries.

Typically, when an owner of property places that property 114 into a trust by way of a properly drafted and executed trust document, he or she turns over part or all of his or her rights to the trustee. This separates the property's legal ownership and control from its settlor's/grantor's ownership and benefits. This controls the property and its benefits if the settlor is absent, incapacitated, or dead. Trusts are frequently created in wills, defining how money and property will be handled for the beneficiaries such as children, relatives, and friends and/or other beneficiaries. The trustee is given legal title to the trust property, but has a legal obligation to act as a fiduciary (i.e., for the good) of the beneficiaries. The benefits of the trust belong to the beneficiary.

The trustee may be either an individual, a company, or a public body. There may be a single trustee or multiple co-trustees. The trust is governed by the terms under which it was created. In most jurisdictions, this requires a contractual trust agreement or deed.

Advantages of a trust may include: a) Avoiding probate, or court intervention, with regard to a person's assets; b) Planning for future events that may affect the property; c) Control of what happens to the Grantor's assets after death; d) Possible reduction of future tax liability; e) Keeping financial affairs confidential when they might otherwise have to be disclosed in probate court; and f) Planning for the Grantor's own disability or incapacity, or providing support for a disabled family member.

As used herein, a “beneficiary” is someone who gets money or other things from somebody else. In trust law the beneficiary is the person who receives property from a trustee. The term “beneficiary” as used herein should be considered as a non-limiting description and include the plural form “beneficiaries.” Unless specifically stated herein, a reference to the term “beneficiary” is also to be construed as including the plural form “beneficiaries” and the term “at least one beneficiary”.

As used herein, a “grantor” is an eligible bestower of a property, real or personal, such as money, real property, an easement, a grant, or a right, such as the one who establishes a trust and transfers his or her property to it. A grantor can also be called a “settlor”. The term “grantor” and/or “settlor” used herein should be considered a non-limiting description and shall include the plural forms “grantors” and/or “settlors”. Unless specifically stated herein, a reference to the term “grantor” and/or “settlor” is also to be construed as including the plural form “grantors” and/or “settlors” and/or “at least one grantor” and/or “at least one settlor”.

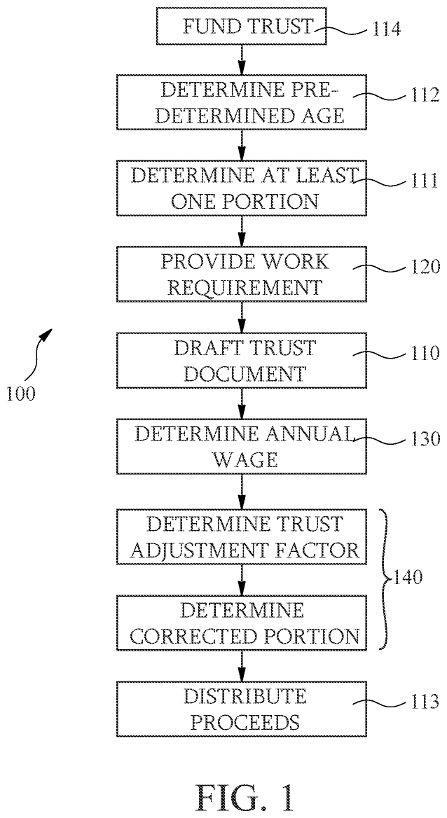

FIG. 1 provides a flow chart of an exemplary process for creating (i.e., drafting) or modifying an existing trust to create a retirement trust incorporating a work requirement 100 consistent with the present disclosure. Simply described, the process for creating a retirement trust incorporating a work requirement 100 provides for a Grantor to fund a trust 114, determine a pre-determined age 112 for the beneficiary, determine at least one portion (a sub-trust) 111, and create a trust document 110 that includes, or can be modified to include, a provision for a work requirement 120 of the beneficiary(s). The trustee then determines whether the work performed by the beneficiary(s) (such as an annual wage) is sufficient 130 under the terms of the trust, and whether a correction is required 140 or not required 150 prior to a distribution of a trust asset to the beneficiary.

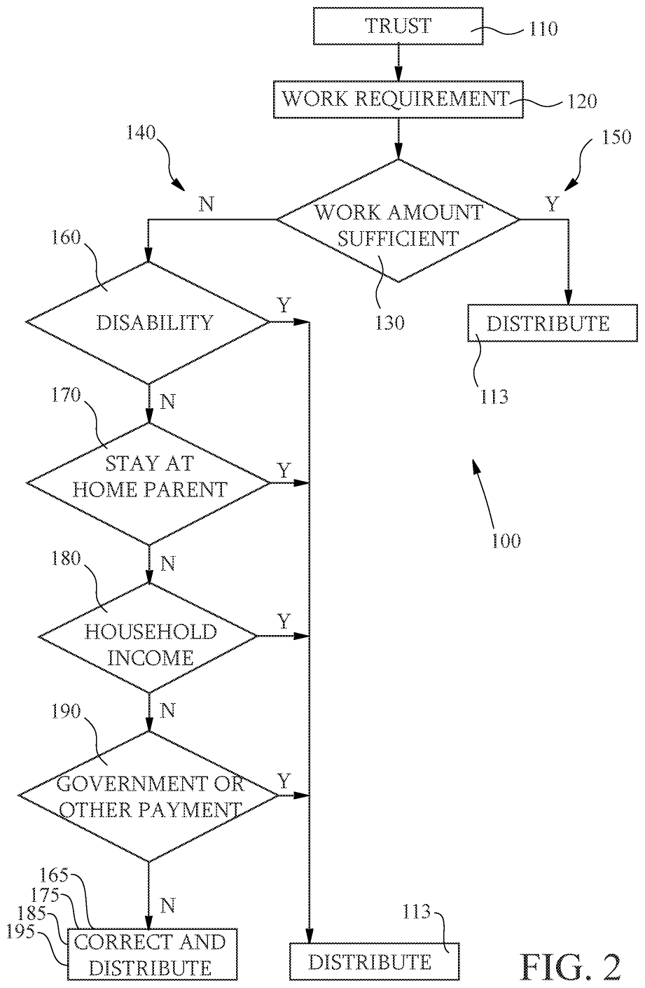

More specifically, as shown in FIGS. 1 and 2, the trust 110 can be a revocable trust that becomes irrevocable upon the death of the Grantor. Upon the death of Grantor, the trust 110 is divided into sub-trusts 111 (also referenced herein as “at least one portion”) for each beneficiary. Each beneficiary has the right to certain distributions 113 of their sub-trust 111 until that beneficiary reaches age a pre-determined age 112. By way of non-limiting example, the grantor may determine that the beneficiary have the right to certain distributions 113 from their sub-trust 111 until the beneficiary reaches a pre-determined age 112 (e.g., 62, 65, or the like as may be desired by the Grantor).

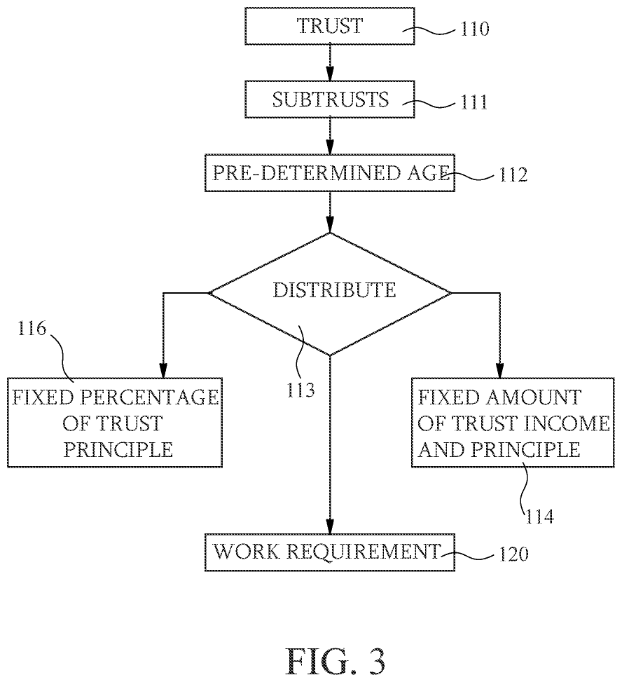

As shown in FIG. 3, the distributions 113 from the sub-trust 111 can be provided until the beneficiary reaches the pre-determined age 112 and can be provided in at least three exemplary manners as determined or chosen by the Grantor. First, the distributions 113 from the sub-trust 112 can be provided as a fixed dollar amount of the trust income and principle 116 until the beneficiary reaches the pre-determined age 112. This distribution 113 can be done at any desired time interval, but typically, annually. Additionally, this distribution 113 can be adjusted for inflation annually as may be required and determined by one of skill in the art.

Second, the distributions 113 from the sub-trust 112 can be provided as a fixed percentage of the trust principle 116 until the beneficiary reaches the pre-determined age 112. This distribution can be done at any desired time interval, but typically, is determined annually with payments made on a monthly or quarterly basis. One of skill in the art will typically provide for such annual distribution to equal 4% of the trust principal. This can be recognized by financial planners of skill in the art as a targeted percentage that prevents the trust from depleting itself in the long term.

Third, the distributions 113 from the sub-trust 111 can include a work requirement 120 until the beneficiary reaches the pre-determined age 112. Such a work requirement 120 can require the beneficiary to provide proof of an annual wage (e.g., income, self-employment income, a multi-year average wage, combinations thereof, and the like) through employment prior to the receipt of any trust assets from either the trust 110 or sub-trust 111. Distributions can be done at any desired time interval, but typically, annually.

The Grantor can pre-determine that the distributions 113 occurring at the pre-determined age 112 (e.g. age 62, 65, or the like as desired by the Grantor) be provided as an annuity to the beneficiary. Alternatively, the Grantor may desire to set a limit on the amount of the distribution per month (or other time period) in lieu of an annuity. This limit can be presented as a fixed dollar amount distribution or a fixed percentage of the assets available in the trust 110 or those of the beneficiary. Such a limit can be useful to prevent depletion of the trust assets in the event the beneficiary has a long, or longer than expected, lifespan. Naturally, one of skill in the art could also have the Grantor mandate that these distribution amounts be adjusted to account for economic inflation.

Further, if desired by the Grantor, the trust 100 or sub-trust 111 can be presented as a so-called “Dynasty Trust” in order to provide for the economic stability for multiple generations. One of skill in the art will recognize that Dynasty Trusts may not terminate—they last for a beneficiary's lifetime. However, at a certain age, a Grantor may choose to have the beneficiary serve as his/her own trustee, giving the beneficiary control over investments and distributions. Dynasty Trusts have advantages that standard trusts do not. Dynasty Trusts can (1) provide for future generations; (2) shield the trust assets from each generation's creditors (including potential spousal claims during a divorce); and (3) enable a portion of the trust to escape estate taxes otherwise due on the passing of each succeeding generation. The Grantor can also provide the right to terminate such a trust, if so required under operation of law or at the option of a beneficiary for the next generation. One of skill in the art will further recognize that this process could ostensibly provide for the ability to distribute a portion of the assets of the trust 100 in favor of the beneficiary(s) descendants where permitted by law upon the death of the beneficiary.

By way of non-limiting example, a first portion of the trust 100 or sub-trust 111 can be distributed to a first generation of beneficiaries and a second portion of the trust 100 or sub-trust 111 can be distributed to a descendant(s) of the first generation of beneficiaries. In this regard, the beneficiary(s) of the trust 110 or sub-trust 110 res can be construed to include a beneficiary, multiple beneficiaries, a descendant(s) of a beneficiary, descendant(s) of multiple beneficiaries, as well as their descendants, combinations thereof, and so on. The trust 100 can provide language that requires the trustee to determine what percentage of the trust 110 or sub-trust 111 assets should be distributed to an at least one beneficiary in order for the trust 110 or sub-trust 111 to maintain sufficient assets to provide for descendants or multiple generations of descendants of the at least one beneficiary.

Additionally, Grantor may provide the trust 100 with the ability to accommodate for the distribution of trust assets occurring at the pre-determined age 112 for qualified medical expenses of the beneficiary. However, one of skill in the art will understand that it may be preferable to limit such distributions to a pre-determined amount. Further, some medical expenses can be excluded from such distributions. This can include, for example, nursing home expenses, the cost of an organ transplant, nursing assistance such as hospice care, in-home medical care, medical treatments, combinations thereof, and the like.

Further, such a trust 100 can provide for a mechanism in the event of the death of a beneficiary, either before, or occurring after, attainment of the pre-determined age 112. For example, the Grantor can determine if the successor-in-interest to the trust 100 must also go through the trust process 100 (with the work requirement 120) described herein. Alternatively, the Grantor can provide a mechanism within the trust 100 that terminates the trust 100 and distributes all the assets of the trust 100 to the heirs of the beneficiary upon the death of the beneficiary either before, or after, attaining the pre-determined age 112.

Returning again to FIGS. 1 and 2, the exemplary process for creating a retirement trust incorporating a work requirement 100 incorporates a work requirement 120. In some circumstances, if a Grantor has a large enough nest egg, a beneficiary may be able to comfortably live off an exemplary 4% of their individual sub-trust 111 each year without having to work. However, it has been surprisingly found that some Grantors do not want their beneficiary living solely off such trust funds. Thus, a work requirement 120 is implemented by the Grantor into their trusts 110 and/or sub-trusts 111.

The work requirement 120 provides for three scenarios. In the first scenario, a beneficiary is entitled to distributions 113 until reaching the pre-determined age 112 that are either: (1) equivalent to their previous calendar year's annual wages; or (2) as a percentage of their previous calendar year's annual wages. In the second scenario, the Grantor can also put a dollar cap or percentage cap on the distribution 113 amount relative to remaining trust 110 assets so that the trust 110 is not depleted too quickly. In the third scenario, if a beneficiary does not work, that beneficiary does not get a distribution 113 until they start working again. In short, the work effort can be quantified by the trustee with the total wages earned by the beneficiary. The wages can be quantified on a weekly, semi-monthly, quarterly, or even an annual basis, or any desired basis as may be required and/or desired by the Grantor as would be understood by one of skill in the art. This third scenario can be provided with exceptions discussed infra.

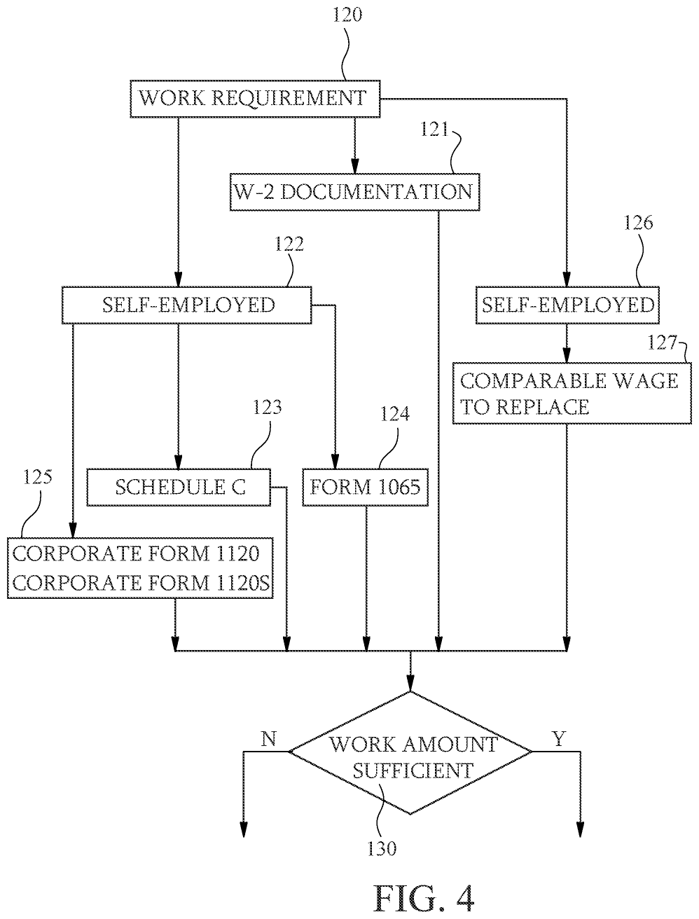

In a non-limiting example, and as represented by the flow chart shown in FIG. 4, the work requirement 120 can be incorporated into the trust 110 and can be evaluated by an annual basis of wage determination of the beneficiary as desired by the Grantor and/or the trust 110. For example, the annual basis of the beneficiary's wage determination for the work requirement 120 can be determined as shown in the following non-limiting examples:

Example 1—The beneficiary's previous year's W-2 wages, a multi-year average of wages, or other documentation 121 verifying employment income can be presented to the Trustee. The beneficiary's right of withdrawal shall not occur until the Trustee receives his or her appropriate documentation.

Example 2—If the beneficiary is a self-employed business owner 122, then annual wages, multi-year average wages, or other documentation 121 can be calculated by a reference to a copy of their Schedule C (if a sole proprietor) 123, a copy of their Form 1065 (if a partnership) 124, or their Corporate Form 1120 or 1120S (if a corporate tax entity) 125 presented to the Trustee.

Example 3—If the beneficiary is a self-employed business owner 126, then annual wages, or multi-year average wages, can be calculated by a comparable wage needed to replace the beneficiary 127 in the business if the business earns more than 3-years annual wages. If the business does not earn more than 3-years annual wages, then the amount is limited to the net income of the business using amounts reported on tax returns with the only adjustment in both situations being that depreciation is to be recorded on a straight-line basis over the life of the assets.

Returning again to FIG. 2, after the work requirement 120 has been determined and incorporated into the trust 110 document, and upon the start of distributions of trust 110 assets to the at least one beneficiary 127, an evaluation of the work requirement 120 to the annual wages earned can be compared to determine whether the annual wages (e.g., work amount) are sufficient 130 to satisfy the work requirement 120 of the trust 110 by the trustee. The comparison of annual wages and their sufficiency in satisfying the trust 110 work requirement 120 creates what can be referenced herein as, or called, a “trust adjustment factor”. The determination by the trustee as to whether the wages earned (i.e., the work performed) by the beneficiary(s) is sufficient 130 under the terms of the trust 110 and/or sub-trust 111, and whether a correction to the amount of a distribution to the beneficiary according to the trust adjustment factor is required 140 or not required 150 prior to a distribution of a trust 110 asset to the beneficiary. In other words, if the earned wages (i.e., work performed) by the beneficiary(s) is sufficient 150 under the terms of the trust 110 and/or sub-trust 111, then the beneficiary has the right to the full amount of the distribution 113 from their sub-trust 111 until the beneficiary reaches the pre-determined age 112. In other words, the full amount of the corrected at least one portion of the trust 110 and or sub-trust 111 is distributed if the trust adjustment factor is zero.

On the other hand, if the earned wages (i.e., work performed) by the beneficiary(s) is not sufficient 140 under the terms of the trust 110 and/or sub-trust 111, then the amount of the distribution 113 from the sub-trust 111 is adjusted according to the trust adjustment factor until either the beneficiary reaches the pre-determined age 112 or the beneficiary increases (i.e., adjusts) their earned wages (e.g., improves their employment behavior) in order to satisfy the work requirement 120 and provide a revised trust adjustment factor that facilitates eligibility for the right to the full amount of the distribution 113 from their sub-trust 111 until the beneficiary reaches the pre-determined age 112. Less than the full amount of the corrected at least one portion of the trust 110 and or sub-trust 111 is distributed if the trust adjustment factor is greater than zero.

Additionally, the Grantor may envision, or at least consider, circumstances when the beneficiary is unable to realize the employment behavior necessary to satisfy the work requirement 120 and become eligible for the right to the full amount of the distribution 113 from their sub-trust 111 until the beneficiary reaches the pre-determined age 112. In this vein, the Grantor may opt to provide certain exemplary and non-limiting exceptions to the work requirement 120.

The first exception to the work requirement 120 may provide for the determination of the amount of disability 160 of the beneficiary and the impact of the disability on the ability of the beneficiary to realize the earned wages that are necessary to satisfy the work requirement 120 and become eligible for the right to the full amount of the distribution 113 from their sub-trust 111 until the beneficiary reaches the pre-determined age 112.

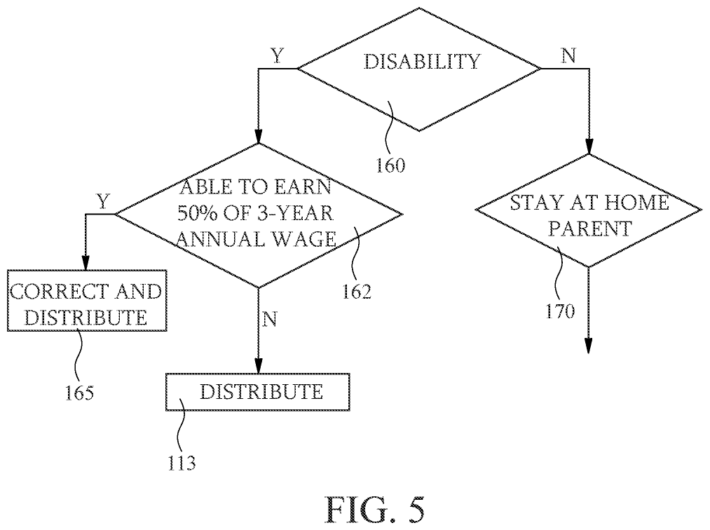

Shown in FIG. 5 is an exemplary, but non-limiting, flow chart depicting a process of how to determine whether a disability 160 indeed affects the ability of the beneficiary to realize the earned wages necessary to satisfy the work requirement 120. First, the determination of the ability to earn 50% or more of the average of the beneficiary's last 3 calendar years' annual wages 162 can be made. If it is determined that the beneficiary is disabled and able to earn 50% or more of the average of their last 3 calendar years' annual wages, then the beneficiary can then be entitled to a corrected distribution 165 by adjusting the distribution amount according to the trust adjustment factor. By way of non-limiting example, the corrected distribution 165 amount could comprise an amount equal to the difference of the beneficiary's average 3-year annual wage and their part time income received from part time employment due to the disability.

However, if it is determined that the beneficiary is disabled and unable to earn 50% or more of the average of their last 3 calendar years' annual wages, then the beneficiary can be, for example, entitled to a distribution 113 equivalent to the withdrawal rights they would otherwise be entitled to upon reaching the pre-determined age 112. In any event, it should be understood by one of skill in the art that it can be preferred that no distribution 113 shall be used to supplant government assistance provided for the beneficiary's disability and no distribution should disqualify the beneficiary for government assistance. Further, one of skill in the art should also recognize that the Grantor and/or trustee should be able to decide whether a drug or alcohol addiction is sufficient and/or capable of meeting the Grantor's definition of a disability or should even be considered as a disability.

A second exemplary exception to the work requirement 120 may provide for the determination of whether the beneficiary is a stay-at-home parent 170 and the stay-at-home parent 170 situation impacts the ability of the beneficiary to realize the earned wages necessary to satisfy the work requirement 120 and become eligible for the right to the full amount of the distribution 113 from their sub-trust 111 until the beneficiary reaches the pre-determined age 112. For example, the beneficiary may not be able to satisfy the work requirement 120 if the beneficiary is required to stay home full-time to care for a dependent. Alternatively, the beneficiary may not be able to satisfy the work requirement 120 because the beneficiary is part of a “traditional” household where the beneficiary is a stay-at-home parent 170 in a household where the spouse or significant other has gainful employment.

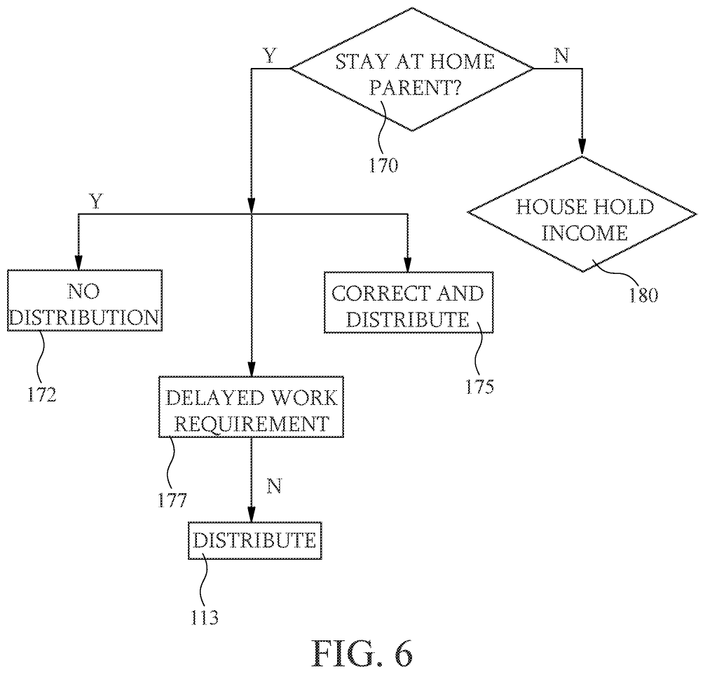

As shown in FIG. 6, if the beneficiary is unable to satisfy the work requirement 120 due to a situation where the beneficiary is a stay-at-home parent 170, several exemplary, but non-limiting, optional analyses and outcomes can be applied. First, the Grantor may demand that the beneficiary will receive no distribution 172 under the terms of the trust 110 and/or sub-trust 111. Alternatively, the Grantor may decide that the beneficiary shall receive a corrected distribution 175 according to the trust adjustment factor under the terms of the trust 110 and/or sub-trust 111. Yet still, the Grantor may decide that the work requirement 120 be delayed 177 until after that beneficiary's dependents achieve the age of majority (e.g., age 18). In this manner, the beneficiary can still be eligible for the right to the full amount of the distribution 113 from their sub-trust 111 until the beneficiary's dependents achieve the age of majority. Then, the beneficiary is thereafter subject to the work requirement 120 and further evaluation thereof.

Returning again to FIG. 2, a third exception to the work requirement 120 can provide for the determination of the beneficiary's total household income 180. For example, if the beneficiary does not meet the conditions and/or aspirations of the work requirement 120, the total household income 180 can be required by the Grantor and/or considered by the Trustee to determine whether the beneficiary can be eligible for the right to the full amount of the distribution 113 from their sub-trust 111. In this circumstance the Grantor can shift the work requirement 120 and its evaluation thereof discussed supra to the spouse and/or significant other of the beneficiary to determine the beneficiary's right to the full amount of the distribution 113 from their sub-trust 111. Alternatively, if the beneficiary's total household income does not meet the conditions and/or aspirations of the work requirement 120, the total household income 180 can be considered by the Trustee to determine whether the distribution 113 from the sub-trust 111 should be adjusted according to the trust adjustment factor.

Returning yet again to FIG. 2, a fourth exception to the work requirement 120 can provide for the determination of the beneficiary's receipts of non-reimbursable government and/or other payments 190. For example, if the beneficiary does not meet the conditions and/or aspirations of the work requirement 120, the receipt of non-reimbursable government or other payments 190 can be considered by the Trustee to determine whether the beneficiary can be eligible for the right to the full amount of the distribution 113 from their sub-trust 111 subject to the trust adjustment factor. In this circumstance the trust can become a so-called “supplemental needs” trust. Alternatively, if the beneficiary's total household income does not meet the conditions and/or aspirations of the work requirement 120, any non-reimbursable government or other payments 190 can be considered by the Trustee to determine whether the distribution 113 from the sub-trust 111 should be adjusted according to the trust adjustment factor.

In an exemplary, but non-limiting embodiment, when the beneficiary obtains the pre-determined age 112, it is believed that the balance of assets remaining in that beneficiary's sub-trust 111 can be totaled and distributed as may be directed by the trust 110 by the Trustee. In other words, the Trustee can take control of the trust 110 and/or sub-trust 111 res, calculate a payment, and distribute a payment to the beneficiary. For example, based upon the assets remaining in the trust 110 or sub-trust 111 upon the beneficiary reaching the pre-determined age 112, the Trustee could calculate a payment to the beneficiary that would result in periodic payments to the beneficiary for the reminder of their life without depleting all trust 110 or sub-trust 111 assets pre-maturely.

By way of a non-limiting example, the Trustee could calculate a payment by utilizing life-expectancy data. The Trustee could utilize an iterative process using this life-expectancy data, apply the life-expectancy data to the beneficiary, and based upon the amount of assets remaining in the trust 110 or sub-trust 111, provide the beneficiary with an annuity payable for the remainder of that beneficiary's life. In any regard, payments to the beneficiary could be paid monthly beginning on the last day of the month in which the beneficiary attains the pre-determined age 112. This payment amount calculated by the Trustee could be payable by Northwestern Mutual and New York Life as annuities payable for the remainder of that beneficiary's life. It should be understood that the trust 110, or sub-trust 111, does not need to have a requirement to purchase an annuity from a life insurance company or companies. Any average payment amount computed by the Trustee merely defines the monthly payment to be made by the trust 110 or sub-trust 111.

Alternatively, when the beneficiary obtains the pre-determined age 112, it is believed that the balance of assets remaining in that beneficiary's sub-trust 111 can be totaled and distributed as may be directed by the trust 110. For example, the assets remaining in the trust 110 could be totaled and the beneficiary provided with a monthly annuity payment. By way of a non-limiting embodiment, a suitable monthly annuity payment and monthly annuity payment amount could be payed from a combination of purchased Northwestern Mutual and New York Life annuities payable for the remainder of that beneficiary's life.

In any regard, it could be provided by the Grantor and/or one of skill in the art that payments to the beneficiary could be paid monthly beginning on the last day of the month in which the beneficiary attains the pre-determined age 112.

One of skill in the art will clearly recognize that Northwestern Mutual and New York Life do not need to be the financial institutions identified in this section of the Trust 110. Any two independent financial institutions that sell annuities can be specified in the Trust 110. In an exemplary, but non-limiting alternative embodiment, the Trustee could use any life expectancy method they feel is appropriate, including, but not limited to, using a different life insurance company's actuarial tables and/or IRS life expectancy tables to compute a monthly benefit to be payable for that beneficiary's life.

Naturally, one of skill in the art will clearly recognize that such an annuity may not necessarily and/or actually be purchased from one of these aforementioned financial institutions. The Trustee can simply obtain a quote from each financial institution, and pay from the trust, the equivalent of the average monthly annuity payment that would have been paid from those financial institutions had an annuity been purchased.

Additionally, one of skill in the art will recognize that a corporate successor trustee is not required for the trust 110. If a Grantor prefers using individual successor trustees, the Grantor can be encouraged by a practitioner to identify a list of several individuals, or entities, to serve in that role. In addition, named successor trustees may be given the right when they are serving as trustee to add and/or delete successor trustees to serve following that successor trustee. However, it should also be recognized that the identification of a corporate successor trustee of last resort can be encouraged and in fact can be beneficial to the outcomes of the process for creating a retirement trust incorporating a work requirement 100 consistent with the present disclosure.

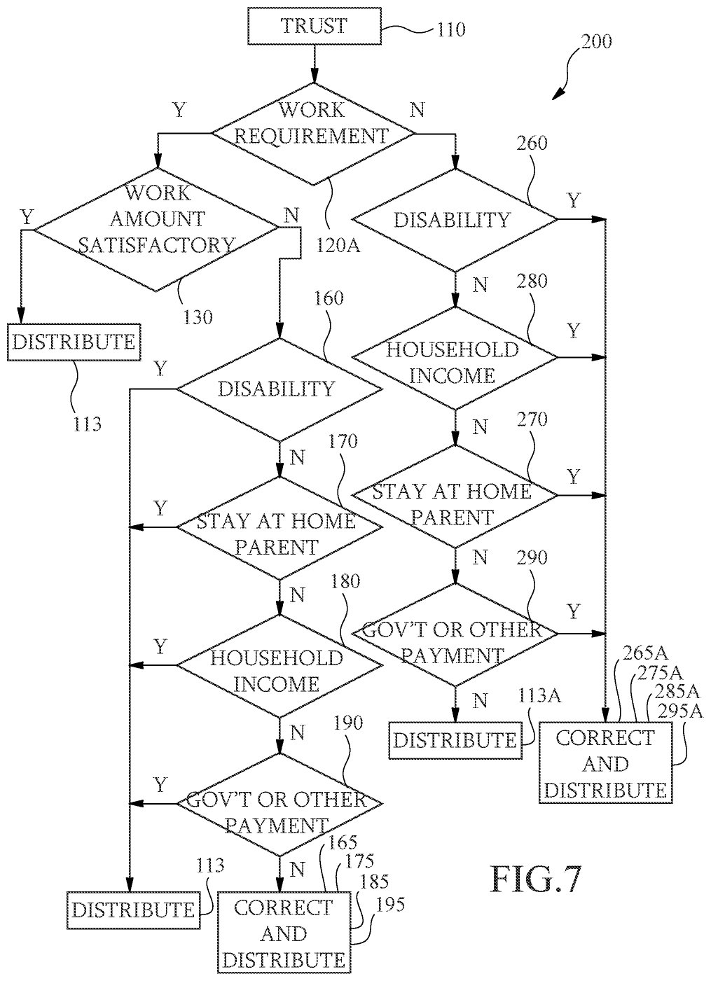

FIG. 7 provides an exemplary alternative embodiment for a process 200 for creating a retirement trust incorporating an optional work requirement 120A, an optional disability requirement 260, an optional stay-at-home parent requirement 270, an optional total house-hold income determination 280, and/or an optional receipt of non-reimbursable government or other payments determination 290 to determine whether a beneficiary can be eligible for the right to the full amount of the distribution 113, 113A from their sub-trust 111 until the beneficiary reaches the pre-determined age 112 or whether a beneficiary can be eligible for the right to a corrected amount of the distribution 165, 265A, 175, 275A, 185, 285A, 195, 295A from their sub-trust 111 until the beneficiary reaches the pre-determined age 112 consistent with the present disclosure.

More specifically, as shown in FIG. 7, the trust 110 can be a revocable trust that becomes irrevocable upon the death of the Grantor. Upon the death of Grantor, the trust 110 is divided into sub-trusts 111 for each beneficiary. Each beneficiary has the right to certain distributions 113 of their sub-trust 111 until that beneficiary reaches age a pre-determined age 112. For example, the grantor may determine that the beneficiary have the right to certain distributions 113 from their sub-trust 111 until the beneficiary reaches a pre-determined age 112 (e.g., 62, 65, or other age selected/determined by the Grantor).

As discussed supra, the distributions 113 from the sub-trust 112 of FIG. 7 can be provided until the beneficiary reaches the pre-determined age 112 and can be provided in three optional and exemplary manners of the Grantor's choosing. First, the distributions 113 from the sub-trust 112 until the beneficiary reaches the pre-determined age 112 can be provided as a fixed dollar amount of the trust income and principle 116. This distribution 113 can be computed annually and be paid monthly or quarterly. Additionally, this distribution 113 can be adjusted for inflation annually as may be required and determined by one of skill in the art. Second, the distributions 113 from the sub-trust 112 until the beneficiary reaches the pre-determined age 112 can be provided as a fixed percentage of the trust principle 116. This distribution can be done annually. One of skill in the art will typically provide for such annual distribution to equal 4% of the trust principle. Third, the distributions 113 from the sub-trust 112 until the beneficiary reaches the pre-determined age 112 can include a work requirement 120A. Such work requirement 120A can require the beneficiary to provide proof of income through employment prior to the receipt of any trust assets from either the trust 110 or sub-trust 111.

By way of non-limiting example, the exemplary process 200 for creating a retirement trust can incorporate an optional work requirement 120A. In some circumstances, if a Grantor has a large enough “nest egg”, a beneficiary may be able to comfortably live off an exemplary 4% of their individual sub-trust 111 each year without having to work. However, a stated supra, it has been surprisingly found that some Grantors may not want their beneficiary living solely off their trust funds. Thus, a work requirement 120A can be implemented into their trust 110 and/or sub-trust 111 processes and resulting trust documents. The work requirement 120A option can be provided in a manner as discussed supra relative to work requirement 120 to provide for a distribution 113 or a corrected distribution 165, 175, 185, 195. The distribution 113 and/or corrected distribution 165, 175, 185, 195 can be analyzed and applied to the work requirement 120A as required by the grantor and one of skill in the art as discussed herein.

Additionally, by way of yet another non-limiting example, the exemplary process 200 for creating a retirement trust can incorporate an optional provision for a stay-at-home parent 270. The optional provision for a stay-at-home parent 270 can be provided in a manner as discussed supra relative to the provision for a stay-at-home parent 170 to provide for a distribution 113A or a corrected distribution 275A. The distribution 113A and/or corrected distribution 275A can be analyzed and applied to the stay-at-home parent 170 as required by the grantor and one of skill in the art as discussed herein.

Further by way of yet another non-limiting example, the exemplary process 200 for creating a retirement trust can incorporate an optional provision for a beneficiary's disability 260. The optional provision for a beneficiary's disability 260 can be provided in a manner as discussed supra relative to the provision for a beneficiary's disability 160 to provide for a distribution 113A or a corrected distribution 265A. The distribution 113A and/or corrected distribution 265A can be analyzed and applied to the beneficiary's disability 160 as required by the grantor and one of skill in the art as discussed herein.

Yet still another non-limiting example can provide an exemplary process for creating a retirement trust can incorporate an optional provision for the beneficiary's receipt of non-reimbursable government or other payments 290. The optional provision for the beneficiary's receipt of non-reimbursable government or other payments 290 can be provided in a manner as discussed supra relative to the provision for the beneficiary's receipt of non-reimbursable government or other payments 290 to provide for a distribution 113A or a corrected distribution 295A. The distribution 113A and/or corrected distribution 295A can be analyzed and applied to the beneficiary's receipt of non-reimbursable government or other payments 290 as required by the Grantor and one of skill in the art as discussed herein.

Finally, by way of yet another non-limiting example, the exemplary process 200 for creating a retirement trust can incorporate an optional provision for the household income 280. The optional provision for a beneficiary's household income 280 can be provided in a manner as discussed supra relative to the provision for a beneficiary's household income 180 to provide for a distribution 113A or a corrected distribution 285A. The distribution 113A and/or corrected distribution 285A can be analyzed and applied to the beneficiary's household income 180 as required by the grantor and one of skill in the art as discussed herein.

It is also envisioned that one of skill in the art will recognize that the trust 100 and processes described herein can be modified in order to provide for the compliance with any legal requirements that may be imposed by local and/or federal estate laws. Further, it is envisioned that the trust 100 and processes described herein can be modified in order to comply with future enacted laws. Still further, one of skill in the art will be able to provide a trust document developed hereunder with the ability for the trust 110 situs to be moved to a jurisdiction that may be a forum conveniens for the trustee, the beneficiary, heirs to the beneficiary, and the like, and combinations thereof upon the death of the Grantor.

Any dimensions and/or values disclosed herein are not to be understood as being strictly limited to the exact numerical values recited. Instead, unless otherwise specified, each such dimension and/or value is intended to mean both the recited dimension and/or value and a functionally equivalent range surrounding that dimension and/or value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for drafting and improving a trust wherein a grantor funds said trust and allocates at least one portion of said retirement trust to at least one beneficiary, said at least one portion of said trust providing a distribution to said at least one beneficiary until said at least one beneficiary obtains a pre-determined age, said process for drafting and improving said trust comprising the steps of:
a) funding said trust by said grantor;
b) determining said pre-determined age of said at least one beneficiary by said grantor;
c) determining said at least one portion of said trust by said grantor to provide said distribution to said at least one beneficiary until said at least one beneficiary obtains said pre-determined age;
d) providing a working requirement of said at least one beneficiary in order to receive said distribution, said working requirement comprising the steps of:
1) determining an annual wage (income) of said at least one beneficiary;
2) determining a trust adjustment factor by comparing said annual wage of said at least one beneficiary determined in said step d1) with said pre-determined age of said at least one beneficiary determined in said step b);
e) drafting a trust document incorporating said working requirement therein;
f) determining a corrected at least one portion of said trust by applying said retirement trust adjustment factor determined in said step d2) to said at least one portion of said retirement trust; and,
g) distributing said corrected at least one portion of said trust to said at least one beneficiary according to said trust document incorporating said working requirement until said at least one beneficiary attains said pre-determined age determined in said step b).

2. The process of claim 1 wherein said step d1) further comprises the step of evaluating the at least one beneficiary's income on an annual basis.

3. The process of claim 2 wherein said step d1) further comprises the step of determining the at least one beneficiary's previous year's income by evaluating the at least one beneficiary's W-2 employment income.

4. The process of claim 2 wherein said step d1) further comprises the step of determining the at least one beneficiary's previous year's income by evaluating the at least one beneficiary's Schedule C (if a sole proprietor), a copy of Form 1065 (if a partnership), or Corporate Form 1120 or 1120S (if a corporate tax entity) if the at least one beneficiary is a self-employed business owner.

5. The process of claim 2 wherein said step d1) further comprises the step of determining the at least one beneficiary's previous year's income by evaluating the comparable wage needed to replace the beneficiary 127 if the at least one beneficiary is a self-employed business owner.

6. The process of claim 2 wherein said step d1) further comprises the step of determining the at least one beneficiary's previous year's income by evaluating a net income of the business using amounts reported on tax returns with the only adjustment being that depreciation recorded on a straight-line basis.

7. The process of claim 2 further comprising the step of distributing the full amount of said corrected at least one portion of said trust if said trust adjustment factor is zero.

8. The process of claim 2 wherein said trust further comprises the step of excepting said work requirement is said at least one beneficiary is unable to satisfy said working requirement.

9. The process of claim 8 wherein said step of excepting said work requirement further comprises the step of determining an amount of disability for said at least one beneficiary impacting the ability of said at least one beneficiary to realize an employment behavior necessary to satisfy said work requirement.

10. The process of claim 8 wherein said determining and amount of disability further comprises the step of determining if said at least one beneficiary is unable to earn 50% or more of the average of said at least one beneficiary's last 3 calendar years' annual wages.

11. The process of claim 10 wherein said corrected distribution comprise an amount equal to the difference of said at least one beneficiary's average 3-year annual wage and said at least one beneficiary's part time income received from said at least one beneficiary's employment.

12. The process of claim 8 wherein said step of excepting said work requirement further comprises the step of determining whether said at least one beneficiary is a stay-at-home parent.

13. The process of claim 12 wherein said step of determining whether said at least one beneficiary is a stay-at-home parent further comprises the step of delaying said work requirement until dependents of said at least one beneficiary achieve the age of majority.

14. The process of claim 13 wherein said step of delaying said work requirement until dependents of said at least one beneficiary achieve the age of majority terminates when said dependents of said at least one beneficiary achieve the age of majority.

15. The process of claim 8 wherein said step of excepting said work requirement further comprises the step of determining the total household income of said at least one beneficiary.

16. The process of claim 15 wherein said step of determining said total household income of said at least one beneficiary further comprises the step of shifting said work requirement to a spouse and/or significant other of said at least one beneficiary.

17. The process of claim 1 further comprising the step of, when said at least one beneficiary obtains said pre-determined age, distributing said trust to said at least one beneficiary.

18. The process of claim 17 further comprising the steps of limiting said distribution to said at least one beneficiary to a first portion of said trust, and distributing a second portion of said trust to a descendant of said at least one beneficiary when said descendent reaches said pre-determined age.

19. The process of claim 17 further comprising the steps of providing a Trustee, having said Trustee determine an annuity distribution amount for said at least one beneficiary, and said Trustee distributing said annuity distribution amount to said at least one beneficiary.

20. The process of claim 1 wherein said step g) further comprises the step of distributing said corrected at least one portion of said trust to said at least one beneficiary as a fixed dollar amount of trust income and principle.

21. The process of claim 1 wherein said step g) further comprises the step of distributing said corrected at least one portion of said trust to said at least one beneficiary as a fixed percentage of trust principle 116 annually.
